(19) United States
(12) Patent Application Publication
(10) Pub. No.: US 2013/0035024 A1
(43) Pub. Date: Feb. 7, 2013

(54) COIN DEPOSITING AND DISPENSING UNIT APPARATUS

(71) Applicant: Kazuya Okawa, Shizuoka-ken (JP)

(72) Inventor: Kazuya Okawa, Shizuoka-ken (JP)

(73) Assignee: TOSHIBA TEC KABUSHIKI KAISHA, Tokyo (JP)

(21) Appl. No.: 13/556,347

(22) Filed: Jul. 24, 2012

(30) Foreign Application Priority Data
Aug. 2, 2011 (JP) 2011-169644

(51) Int. Cl. G07D 1/00

(52) U.S. Cl. 453/18

(57) ABSTRACT

A coin depositing and dispensing apparatus comprises a storing section configured to select and store a deposited coin according to a denomination, a coin conveying unit configured to convey the coin stored in the storing section, a switching member configured to switch a coin conveying route of the coin conveying unit to either a coin dispensing path for dispensing the coin from a coin dispensing port or a coin collecting path where a coin collecting bag is provided for collecting the coin and a regulating unit configured to restrict the switching to the coin collecting path by the switching member if the coin collecting bag is mounted but not located at a specified coin collecting position.

### CROSS-REFERENCE TO RELATED APPLICATION

This application is based upon and claims the benefit of priority from Japanese Patent Application No. 2011-169644, filed Aug. 2, 2011, the entire contents of which are incorporated herein by reference.

### FIELD

The embodiments of the present invention relate to a coin depositing and dispensing apparatus.

### BACKGROUND

At present, a coin depositing and dispensing apparatus that receives coins according to each denomination of coin such as 1 yen, 5 yen, 10 yen, 50 yen, 100 yen, and 500 yen and dispenses coins in the coin storing section by a change amount to the coin dispensing port in response to a change dispensing instruction from a POS terminal or ECR is widely used.

Such coin depositing and dispensing apparatus is also installed in a so-called self-checkout machine on which a customer himself/herself conducts the account processing (checkout processing).

### BRIEF DESCRIPTION OF THE DRAWINGS

FIG. 1 is an external perspective view of a coin depositing and dispensing apparatus according to an embodiment;

FIG. 2 is a plan view of a depositing and dispensing unit without a housing;

FIG. 3 is a block diagram of the general construction of a control system of the coin depositing and dispensing apparatus;

FIG. 4 is a longitudinal sectional view showing a coin selecting section and a coin storing section;

FIG. 5 is an external perspective view of a switching member (Part 1);

FIG. 6 is an external perspective view of the switching member (Part 2);

FIG. 7 is a side view of the switching member;

FIG. 8 is an external perspective view of a coin tray portion;

FIG. 9 is a perspective view illustrating mounting operation of a dispensing-collecting bag before dispensing-collecting operation;

FIG. 10 is a sectional view corresponding to the state of FIG. 9, taken in the direction of arrow A-A (referring to FIG. 2);

FIG. 11 is a side view illustrating the operating state of the switching member;

FIG. 12 is a perspective view illustrating the operating state of the switching member;

FIG. 13 is a perspective view illustrating the state of the dispensing-collecting bag mounted in a collection rail;

FIG. 14 is a sectional view corresponding to the state of FIG. 13, taken in the direction of arrow A-A (referring to FIG. 2);

FIG. 15 is a sectional view corresponding to the state in which the dispensing-collecting bag being further pressed into from the state of FIG. 13, taken in the direction of arrow A-A (referring to FIG. 2);

FIG. 16 is perspective view illustrating a state in which the dispensing-collecting bag being mounted in the collection rail and pressed to a dispensing-collecting position;

FIG. 17 is a sectional view corresponding to the state of FIG. 16, taken in the direction of arrow A-A (referring to FIG. 2); and

FIG. 18 is an explanatory view illustrating a dispensing-collecting operation.

### DETAILED DESCRIPTION

According to one embodiment, a coin depositing and dispensing apparatus comprises a storing section configured to select and store a deposited coin according to a denomination, a coin conveying unit configured to convey the coin stored in the storing section, a switching member configured to switch a coin conveying route of the coin conveying unit to either a coin dispensing path for dispensing the coin from a coin dispensing port or a coin collecting path where a coin collecting bag is provided for collecting the coin and a regulating unit configured to restrict the switching to the coin collecting path by the switching member if the coin collecting bag is mounted but not located at a specified coin collecting position.

The coin depositing and dispensing apparatus according to the embodiment will be described below in detail with reference to the accompanying drawings.

The embodiment is an example of application to a coin depositing and dispensing apparatus that conveys coins put in from a coin slot and sorts them in the coin sorting section according to a coin denomination and stores them in a coin storing section, and dispensing them according to a coin denomination in response to a coin dispensing instruction.

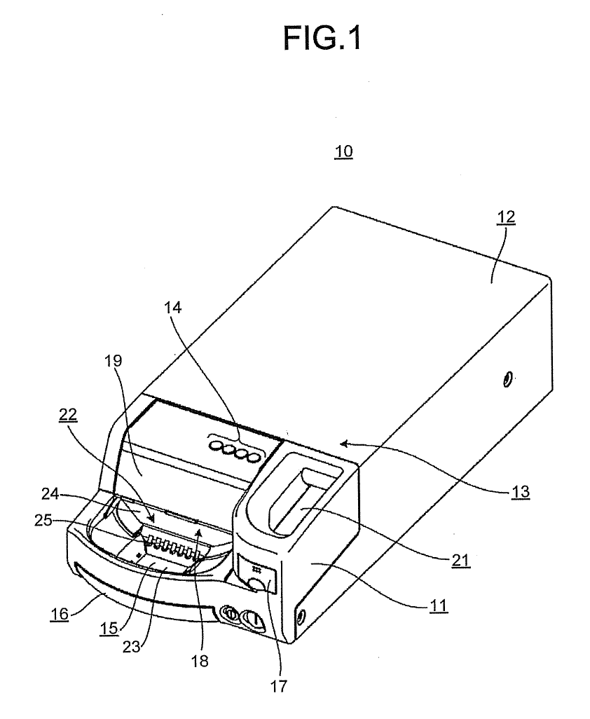

FIG. 1 is an external perspective view of the coin depositing and dispensing apparatus according to an embodiment.

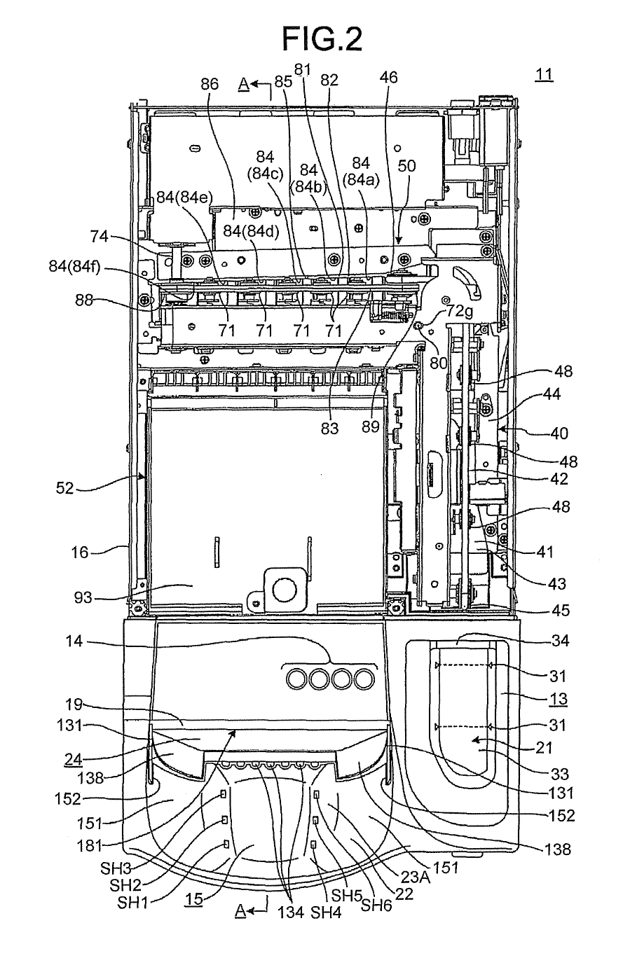

FIG. 2 is a plan view of a depositing and dispensing unit.

The coin depositing and dispensing apparatus 10, as shown in FIG.1, comprises or is roughly divided into a depositing and dispensing unit 11 that conducts the depositing and dispensing of coins, and a storage case 12 that accommodates and retains the depositing and dispensing unit 11 in a manner of being able to be pulled out.

The depositing and dispensing unit 11, as shown in FIG.1 and FIG. 2, comprises a coin receiving section 13 that is located at the front part of the coin depositing and dispensing apparatus 10 and accepts coins deposited, an operation panel 14 having a plurality of operation elements that conducts various operations, and a coin dispensing section 15 that dispenses and retains coins.

The depositing and dispensing unit 11, as shown in FIG. 1, includes a handle portion 16 that is arranged under the coin dispensing section 15 and used for drawing out the collection rail, supporting a collecting bag mounting portion to which a dispensing-collecting bag described below is attached, from the storage case 12 to the front, a reject box 17, that is hold in the depositing and dispensing unit 11 such that it is able to be drawn out therefrom, retains the discharge object i.e. deformed coins, a coin dispensing port 18 that dispenses coins and a cover 19 that forms the coin dispensing port 18.

In the construction described above, a coin receiving section 13 includes a coin slot 21 used for depositing coins. The coin slot 21 permits the thrown-in of a large amount of coins at a time. Multiple sets of depositing sensor 31 that photo-electrically detects the coins deposited are arranged in the coin slot 21.

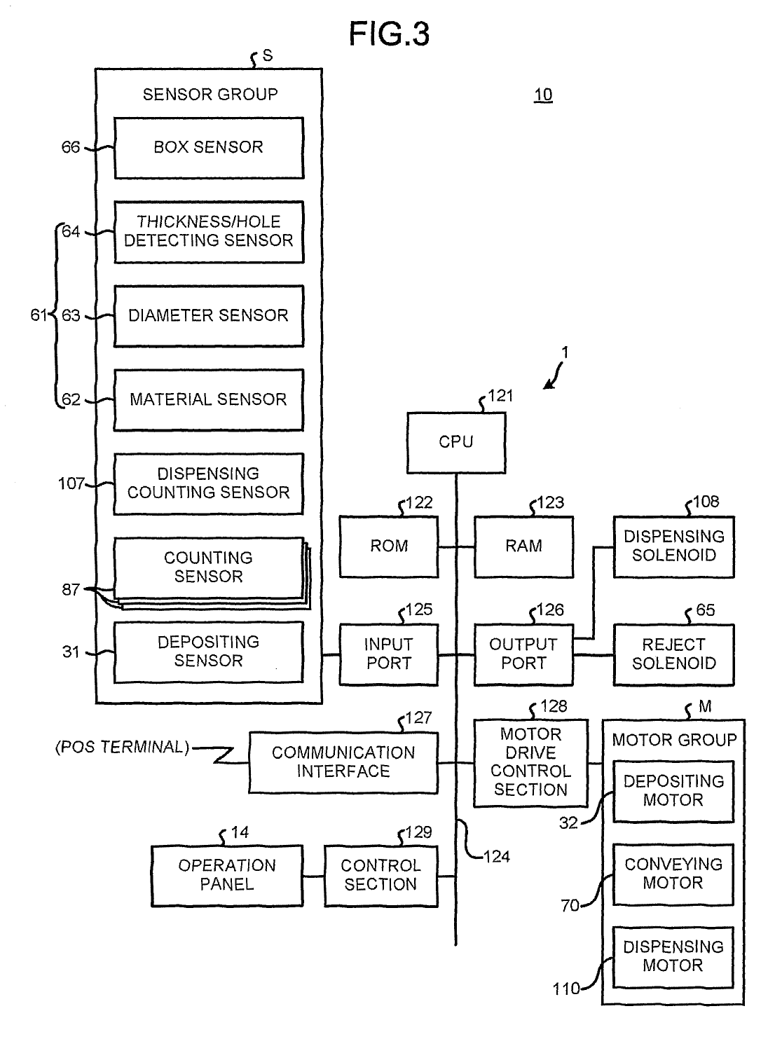

FIG. 3 is a block diagram of the general construction of a control system of the coin depositing and dispensing apparatus.

A depositing belt 33 that is rotated by a depositing motor 32 (referring to FIG. 3) and conveys the coins into the interior of the coin depositing and dispensing apparatus 10 is arranged at the bottom of the coin slot 21. A depositing pulley 34 that isolates the coins conveyed by the depositing belt 33 one by one and sends them out is arranged at the halfway of the depositing belt 33.

The coin dispensing section 15 includes a tray portion 22 used for retaining the coins dispensed. A retention portion 23 used for retaining the coin conveyed by the coin conveying unit described below is arranged at the bottom of the tray portion 22. The tray portion 22 includes a switching member 24 which rotates to selectively switch the conveying destination of the coins conveyed by the coin conveying unit to the retention portion 23 or a dispensing-collecting bag described below, and a finger insert preventing portion 25 that occupies the gap between the retention portion 23 and the switching member 24 and prevents finger from inserting.

A coin conveying unit 40 is arranged at the rear part of the depositing pulley 34.

The coin conveying unit 40 includes a coin conveying surface 41, and a conveying belt 42 that presses coins to the conveying surface 41 while it conveys the coins.

The coin conveying surface 41 is arranged at a position receiving the coins conveyed by the depositing belt 33 at the downstream side of the depositing belt 33 in the coin convey direction. The coin conveying surface 41 is formed with the upper surface of a conveying base 43. A conveying guide member 44 is fixed at a right side of the coin conveying base 43 in the coin conveying direction of the coin conveying surface 41 in FIG. 2. The conveying base 43 and the conveying guide member 44 are made of metal being harder than the conveying object i.e. coins.

The conveying belt 42 is a rubber endless belt, and its cross-section is formed in a circular shape. The conveying belt 42 extends from the depositing belt 33 to the selecting belt 83 described below which is used for selecting coins.

The conveying belt 42 is located at a position, above the coin conveying surface 41, where it presses coins to the coin conveying surface 41.

The conveying belt 42 is extended between a pulley 45 and a pulley 46 corresponding to the pulley 45. The end portion of the conveying belt 42 is bent at a nearly right angle to selecting belt 83 by a pair of pulleys 47 (pulley at the underside is not shown) arranged between the pulley 46 and the pulley 45. Thus, conveying belt 42 is formed in an approximately “L” shape (seen from the above thereof). A pair of pulleys 47 is connected to each other and is rotatable in opposite directions. In addition, the inner surface of a portion of the conveying belt 42 opposite to the coin conveying surface 41 is supported by a plurality of idler pulley 48.

The pulley 46 rotates in a uniform speed by transmitting the driving force from the conveying motor 70 (referring to FIG. 3) connected via the selecting belt 83, and the conveying belt 42 also uniformly rotates due to the uniform rotation of the pulley 46.

The coins conveyed by the depositing belt 33 are sandwiched between the conveying belt 42 and the coin conveying surface 41 at the downstream side of the pulley 45, and are pressed on the coin conveying surface 41 while they are conveyed with drive of the conveying belt 42, and reach to a coin selecting section 50.

The conveying guide member 44 is arranged in a manner of interfering the conveying path of the coins conveyed on the depositing belt 33. The conveying guide member 44 is provided with a first slope of angle α against the conveying belt 42, and a second slope of angle β against conveying belt 42. In addition, the relationship between the angle α of the first slope and the angle β of the second slope is angle α>angle β. The second slope is located at the downstream side of the first slope in the coin convey direction. Due to the angel of the conveying guide member, the width of the conveying path of coin conveyed on the depositing belt 33 is gradually narrowed.

A coin discrimination section 61 that discriminates coins (referring to FIG. 3) is arranged at a position on the coin conveying surface 41, that is upstream side of a reject hole 33a described below in the coin convey direction, where the coins pass. The coin discrimination section 61 includes a first discrimination sensor i.e. material sensor 62 that detects the material of coins, a second discrimination sensor i.e. diameter sensor 63 that detects the diameter of coin, and a third discrimination sensor i.e. thickness/hole detecting sensor 64 that detects the thickness of coin and presence or absence of hole. The material sensor 62 of the 3 types of discrimination sensor 62, 63, 64 is arranged at the most upstream side in the coin conveying direction, and the diameter sensor 63 is arranged at the most downstream side. Then, the thickness/hole detecting sensor 64 is arranged between the material sensor 62 and the diameter sensor 63 in the coin convey direction.

Instead of the thickness/hole detecting sensor 64, a sensor that can detect other coin information besides materials and diameter, such as, the reflectance of coin or the concavo-convex shape of coin may be used.

The material sensor 62, the diameter sensor 63 and the thickness/hole detecting sensor 64 are respectively constructed as a magnetic sensor having, for example, a coil, an oscillating circuit connected to the coil, a rectifier circuit connected to the oscillating circuit.

If a coin approaches the coil of material sensor 62, diameter sensor 63 and thickness/hole detecting sensor 64, the impedance of the coil varies and then the oscillation level of the oscillating circuit varies in response to the variation of the impedance of the coil. The rectifier circuit rectifies the output waveform of the oscillating circuit into a waveform corresponding to a digital signal and outputs it to a CPU 121 (referring to FIG. 3).

The CPU 121 compares its output value with the value of genuine coin set beforehand to carry out the true/false discrimination of coin (determining of whether coin is a qualified coin i.e. genuine coin or a false coin i.e. counterfeit coin). In case that its output value is different from the set value of genuine coin, the CPU 121 determines that the coin is a false coin. The variation amount of the oscillation level of the oscillating circuit is set such that: the material sensor 62 being different depending on the material of coin, the diameter sensor 63 being different depending on the diameter of coin, and the thickness/hole detecting sensor 64 being different depending on the presence or absence of the hole of coin or, thickness of coin.

A reject hole, not shown, through which the coins with greatest diameter may drop is formed at a position where coins at downstream end of the coin conveying surface 41 in the coin convey direction pass, but part of the hole is blocked by a reject shutter (not shown). In this state, any coin may not fall down. This reject shutter is driven by a reject solenoid 65 to be opened/closed (referring to FIG. 3). For example, in case that coin is determined as a false coin, after a predefined given time from the detection of the information of the coin, the reject shutter is opened, and let the coin fall from the reject hole. The reject box 17 (referring to FIG. 1) is arranged under the reject hole.

The reject box 17 receives and stores the coins dropping from the reject hole. The reject box 17 is supported on the support portion arranged in the housing of the depositing and dispensing unit 11 such that it is able to be pull out. The box sensor 66 (referring to FIG. 3) that detects the mounting state of the reject box 17 is arranged at the support portion.

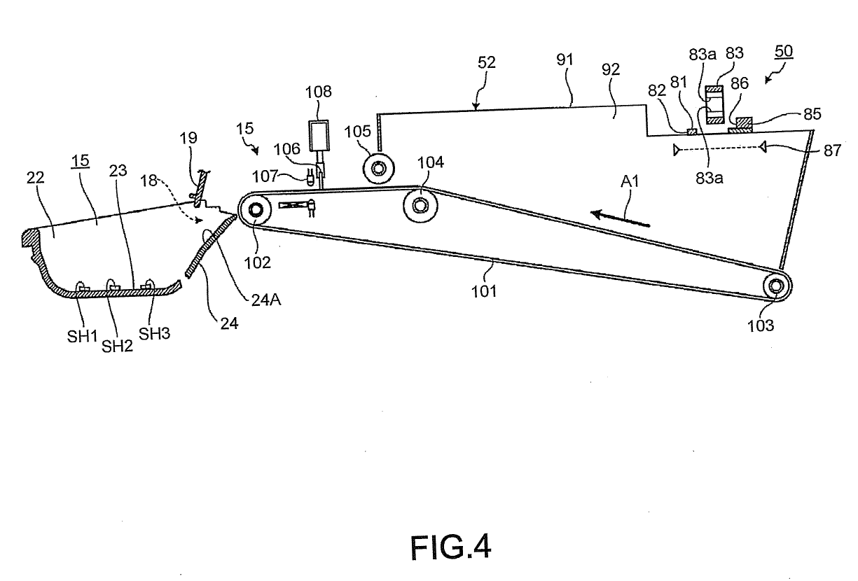

FIG. 4 is a longitudinal sectional view showing coin selecting section and coin storing section.

The coin selecting section 50 includes a selecting base 82 in which a coin conveying surface 81 is formed on the upper surface thereof, and a selecting belt 83 that presses coin to the coin conveying surface 81 while the belt 83 conveys the coin.

In FIG. 2, the coin conveying surface 81 extends in the right and left direction at a right angle against the coin conveying surface 41, and a coin conveying surface with an “L” shape is formed by the coin conveying surface 81 and the coin conveying surface 41.

In the selecting base 82, selecting holes 84a, 84b, 84c, 84d, 84e, and 84f, corresponding to denomination of coin, width dimensions of which are successively wider toward the downstream side in the coin conveying direction are provided such that they respectively penetrate the coin conveying surface 81.

In FIG. 2, six selecting holes 84a, 84b, 84c, 84d, 84e, and 84f are arranged from right side in a manner corresponding to each denomination of 1 yen, 50 yen, 5 yen, 100 yen, 10 yen, and 500 yen. That is, the selecting hole 84f of 500 yen (highest denomination of coin) is located at the most left side of the selecting holes 84a, 84b, 84c, 84d, 84e, 84f. Hereinafter, for convenience of description purpose, in case that the selecting holes 84a, 84b, 84c, 84d, 84e, 84f are not needed to be particularly distinguished, they are referred to as the selecting hole 84.

In this embodiment, adjacent selecting holes 84 in the coin conveying direction are formed continuously in connecting with each other thereby forming one aperture for the sake of appearance. Coins are conveyed in the coin selecting section 50 and coins respectively drop to the coin storing section 52 through selecting holes 84 when coins reach the selecting holes respectively having corresponding width dimensions according to the denomination.

A reference member 85 is fixed on the selecting base 82, and a reference surface 86 is formed on the reference member 85. The reference surface 86 supports the lateral side of coins, and coins are conveyed while the lateral side thereof is contacted with the reference surface 86, thereby a correct coin selection can be carried out according to the selecting holes 84. In addition, a counting sensor 87 that detects the dropping coins (referring to FIG. 2) is provided to each selecting hole 84.

The selecting belt 83 is provided at a position of upper part of the coin conveying surface 81 at which coins are pressed to the coin conveying surface 81. The selecting belt 83 is a rubber endless belt, and a plurality of teeth 83a are formed on the inner periphery of the belt. The selecting belt 83 is extended between a pulley 88a and a pulley 89 arranged correspond to the pulley 88.

The pulleys 88 and 89 are pulleys with teeth that are provided with a plurality of teeth at the outer periphery that mesh with the teeth 83a of the selecting belt 83.

The pulley 88 is a driving pulley, and arranged above the selecting hole 84f for a coin of highest denomination (500 yen). The pulley 88 uniformly rotates with the drive force transmitted from the conveying motor 70 (referring to FIG. 3), and the selecting belt 83 also uniformly rotates due to a uniform rotation of the pulley 88.

The pulley 89 is a driven pulley and arranged upstream side of each selecting hole 84 in the coin conveying direction. The pulley 46 of the coin conveying unit 40 is fixed on the same shaft as the pulley 89. The inner periphery of the selecting belt 83 opposite to the coin conveying surface 81 is supported by a plurality of idler pulleys 71. In this way, if the pulley 88 uniformly rotates by the conveying motor 70 in a state that the selecting belt 83 meshes with the pulleys 88 and 89, the selecting belt 83 also uniformly rotates. The pulley 46 fixed on the pulley 89 also operate simultaneously with the pulley 89 and uniformly rotates, as a result, a constant drive force can be transmitted from the selecting belt 83 to the conveying belt 42, thus a coin conveying can be performed suitably.

The selecting belt 83 and the reference surface 86 are arranged such that the belt 83 and surface 86 come close to each other toward the downstream side in the coin convey direction, and accordingly the selecting belt 83 forces coins to the reference surface 86 for conveying. Since the cross-section of the selecting belt 83 is substantially rectangular, the area which the belt 83 contacts with the conveyed coin is wide compared with a case that the cross-section of the belt is a circular shape. Therefore, the selecting belt 83 contacts the coin with a large area to convey while pressing the coin to the coin conveying surface 81, and then the selecting belt 83 can conveys the coin more accurately.

The coin storing section 52, as shown in FIG. 2 and FIG. 4, is arranged at a position that coins dropped through the selecting hole 84 are received, and thus the coin storing section 52 stores the coins dropped according to the denomination. The coin storing section 52 is divided into a plurality of storage chambers 92 corresponding to each denomination by partition plates 91. Each storage chamber 92 is communicated with the corresponding selecting hole 84. An aperture is made on the upper surface of the storage chamber 92 and the aperture is covered by the cover 93, etc.

The coin dispensing section 15, as shown in FIG. 4, includes a dispensing belt 101 arranged at the bottom of each storage chamber 92. The dispensing belt 101 is extended between the pulleys 102, and 103. The pulley 102 is a driving pulley, and the pulley 103 is a driven pulley. In addition, the dispensing belt 101 is supported by the idler pulley 104.

The pulley 102 is driven by the dispensing motor 110 (referring to FIG. 3) to rotate, thereby rotating the dispensing belt 101. In FIG. 4, the dispensing belt 101 conveys the coins in the direction shown by the arrow A1, that is, form the rear part of the coin selecting section 52 towards the front part thereof.

The coin dispensing section 15 includes a reverse roller 105 arranged at the outlet of the coin selecting section 52, a dispensing shutter 106, and a dispensing-counting sensor 107.

The reverse roller 105 rotates in the same direction as the dispensing belt 101 and thus the coins are dispensed one by one by the dispensing belt 101.

The dispensing shutter 106 is open and close by the dispensing solenoid 108. In its closed state, the dispensing shutter 106 makes coins standby and on the other hand, in the open state, permits the dispensing belt 101 to dispense the coins.

The dispensing-counting sensor 107 detects the coins dispensed by the dispensing belt 101.

As shown in FIG. 1, a coin dispensing port 18 is provided below the end position (front end) of the conveying belt 42. The coin dispensing port 18 dispenses out the coins with the dispensing belt 101. As shown in FIG. 2, the coin dispensing port 18 is arranged at the left side of the coin slot 21.

As shown in FIG. 3, the coin depositing and dispensing apparatus 10 is equipped with a CPU 121 as an information processing section. A ROM 122 in which basic or regular data such as programs etc are stored beforehand and a RAM 123 that stores various data in a rewritable manner are connected to the CPU 121 via a system bus 124. The CPU 121, ROM 122 and RAM 123 constitute a microcomputer.

The CPU 12 connects, through the system bus, with an input port 125 which inputs signals from sensors S such as an depositing sensor 31, a counting sensor 67, a dispensing-counting sensor 107, a box sensor 66, a material sensor 62, a diameter sensor 63, and a thickness/hole detecting sensor 64, an output port 126 which outputs drive signals to a reject solenoid 65, and a dispensing solenoid 108, a communication interface 127 electrically connected to the POS terminal, a motor drive control section 128 which drive-controls motors M such as a depositing motor 32, a conveying motor 70, and a dispensing motor 110, and an operation control section 129 which is connected with the operating panel 14 to receive a key-signal input by the operation elements. And these sections are drive-controlled by the CPU 121 according to the program.

In such construction, if coins are deposited into the coin slot 21, the coins are detected by the depositing sensor 31. By the reception of the detected signal from the depositing sensor 31, the CPU 121 drives the depositing motor 32 and the conveying motor 70 to rotate the depositing belt 33, the conveying belt 42 and the selecting belt 83. Then, with the rotation of the conveying belt 42, the coins are conveyed to the coin conveying surface 41. The coins are further conveyed toward the downstream side in the coin conveying direction

The conveying belt 42 conveys the coins in such a way that the lateral side of coin on the conveying path which becomes gradually narrow is pressed to the conveying guiding member 44. Therefore, the coins respectively follow the same trailing passage according to the denomination of each coin and are respectively conveyed on the coin conveying surface 41.

In addition, as previously described, since a relationship between the angle α of the first slope and the angle β of the second slope is angle α>angle β, the coin coming from the coin slot 21 can be moved to sideways at a short distance at the conveying guide member 44 of the upstream side in the coin conveying direction.

As described above, coin is pressed to the conveying guide member 44 while the coin is conveyed on the coin conveying surface 41. It is called as one sideway conveying. The reason that the coin is conveyed with the sideway conveying is following. In the case in which discrimination of coin diameter is carried out at that time of the coin discrimination by the diameter sensor 63, coin is forcibly moved to the guide in a manner of one sideway and fixedly located, and then a coin discrimination by the diameter sensor 63 is executed. Thus, it is required that a coin coming from the coin slot 21 is forcibly moved to the conveying guide member 44 in a manner of one sideway, when coin discrimination is executed.

The coin that is conveyed in a manner that it is pressed to the conveying guide member 44 on the coin conveying surface 44 (one sideway conveying) passes through the material sensor 62, the thickness/hole detecting sensor 64 and the diameter sensor 63.

The CPU 121 carries out a coin discrimination based on the output of the material sensor 62, the thickness/hole detecting sensor 64 and the diameter sensor 63. If the coin that is conveyed is determined as a genuine one, the CPU 121 does not drive the reject solenoid 65, and the reject shutter driven by the reject solenoid 65 is maintained at the closed state. Therefore, the coin dose not drop through the reject hole 33a (not shown) and is conveyed to the coin selecting section 50. On the other hand, if the coin is determined as a false coin, the CPU 121 drives the reject solenoid 65 and makes the reject shutter to the open state. Thereby, the coin determined as a false coin drops through the reject hole 33a and is stored in the reject box 53.

In the coin selecting section 50, coin is conveyed by the selecting belt 83, and drops through the corresponding selecting hole 84 and is stored in the coin selecting unit 52. At this moment, since the selecting belt 83 and the reference surface 86 are arranged in a manner of becoming close to each other toward the downstream side in the coin conveying direction, the selecting belt 83 presses the lateral side of the coin to the reference surface 86 while conveying the coin.

If a coin dispensing instruction from the POS terminal is transmitted, the CPU 121 drives the dispensing belt 101 and, at the same time, drives the dispensing solenoid 108 according to the denomination, thus the required number of coins are dispensed to the coin dispensing port 18.

As a result, the coins slide down on a movable coin receiving surface 24A which is formed as a surface of the switching member 24 and are held on the tray portion 22 of the coin dispensing section 15.

The construction of the switching member 24 is described.

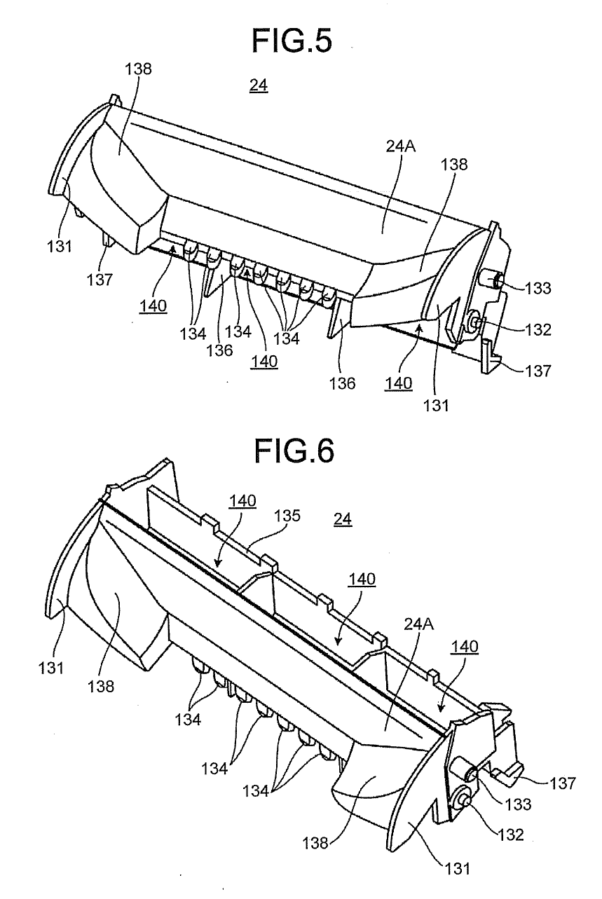

FIG. 5 is an external perspective view of the switching member (Part 1).

FIG. 6 is an external perspective view of the switching member (Part 2).

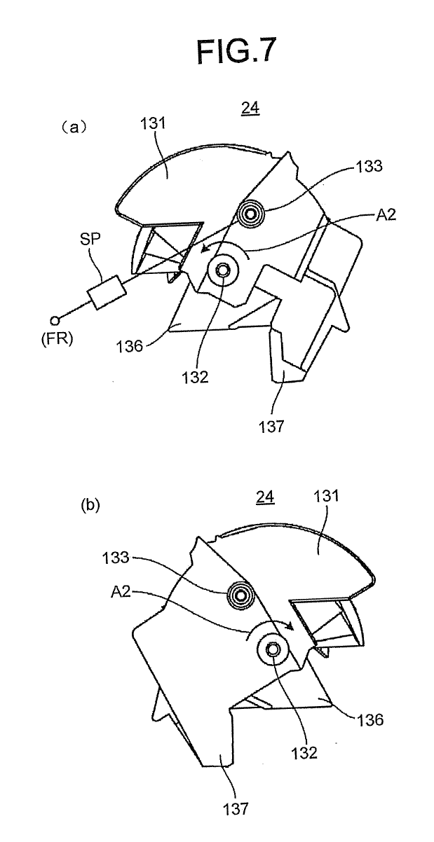

FIG. 7 is a side view of the switching member.

Wherein, FIG. 7(a) is a right side view and FIG. 7(b) is a left side view.

A pair of plate-shaped rotation guide plates 131 are arranged at both sides of the switching member 24 respectively.

At the both ends of the switching member 24, a rotation shaft 132 which rotationally supports the main body of the switching member 24 and is inserted into a bearing hole (not shown) that is provided at the frame FR (located at the back side and the front side in FIG. 5) which supports each portion of the coin depositing and dispensing apparatus 10 is provided.

A projection 133 for urging is arranged above the rotation shaft 132. A spring SP one end of which is fixed on the frame FR is connected to the projection 133 to give a rotation moment with which the switching member 24 is rotated around the rotation shaft 132 as an rotation axis in the direction of the arrow A2.

At the lower end of the movable coin receiving surface 24A, a plurality of insert preventing projection portion 134 is provided.

A coin collecting path 140, that is used as a coin conveying route when the coins are collected, is constituted with the backside of the movable coin receiving surface 24A and a partition plate 135 which is arranged so as to be opposite to the backside of the movable coin receiving surface 24A.

A pair of rotation regulating plates 136 is provided under the switching member 24 such that the rotation regulating plate pair 136 protrudes from the inside of the coin conveying route when the coin is collected to the lower side. A pair of abutting members 137 protrudes from the lower-most end portion of the switching member 24. The switching member 24 is rotated when the frame of the coin collecting bag described later contacts the pair of abutting members 137.

A pair of movable guide slope portions 138 is arranged in a manner of intersecting with the movable coin receiving surface 24A.

Then, construction of the coin tray portion will be described.

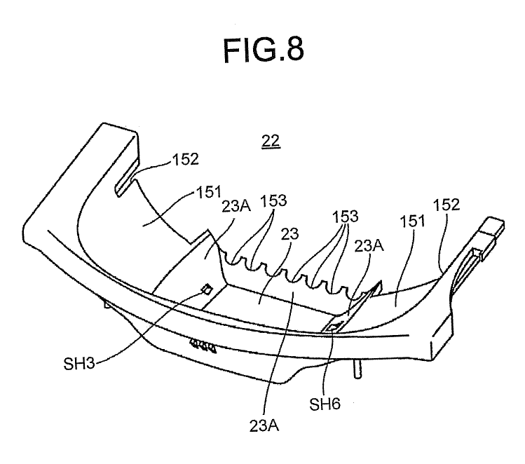

FIG. 8 is an external perspective view of coin tray portion.

As shown in FIG. 8, the retention portion 23 used for retaining coins conveyed by the coin conveying unit is arranged at the bottom of the tray portion 22.

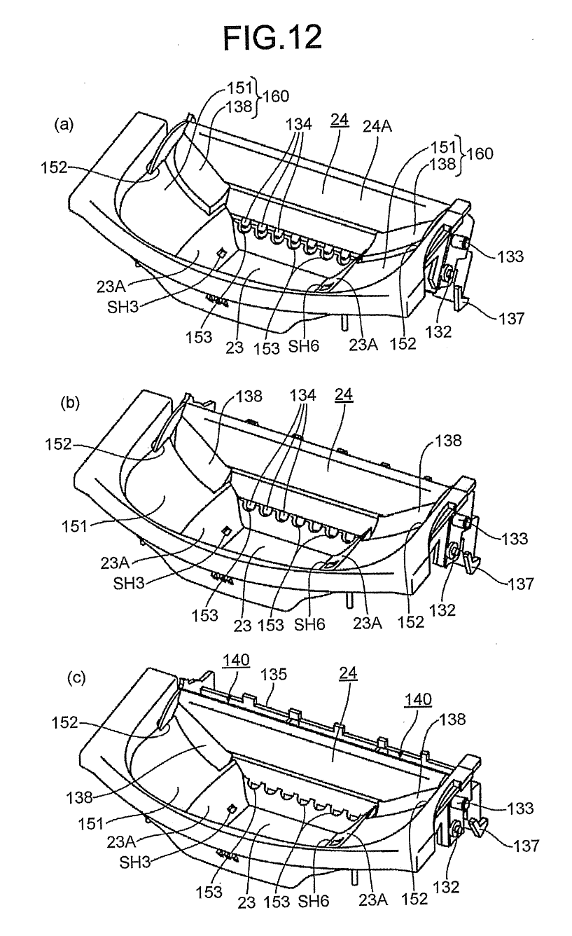

In addition, the tray portion 22 includes a fixed guide slope portion 151 used for guiding the coins dispensed to the retention portion 23, and, compared with the wall portion 23A of the retention portion 23, the fixed guide slope portion 151 gradually forms a slope. Then, the fixed guide slope portion 151 and the movable guide slope portion 138 of the switching member 24 work together and constitute a guide slope portion 160 (referring to FIG. 12) that guides the dispensed coins to the retention portion 23.

In FIG. 8, holes SH1-SH6 used as a coin detecting sensor are arranged at the pair of wall portions 23A arranged at both sides of the tray portion 22. In addition, the top end portion of the wall portion 23A arranged at the inner side of the tray portion 22 is cut in a wave fashion and constructs a plurality of insert preventing recess portions 153. The insert preventing projection portion 134 of the switching member 24 is arranged opposite to each insert preventing recess portion 153 and works together with each insert preventing recess portion 153 thereby preventing the insert of nails or fingers of a user. That is, at the time of rotation of the switching member 24, the rotation thereof is not bothered and the gap caused by the rotation becomes smaller as possible as one can thus preventing the insert of nails or fingers.

Then, the operations during the dispensing collection according to the embodiment will be described.

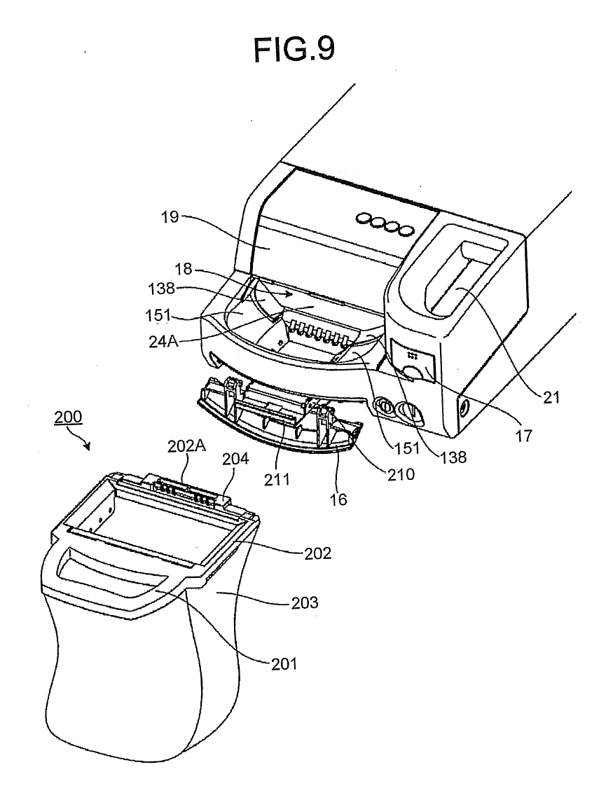

FIG. 9 is a perspective view illustrating the mounting operation of dispensing collecting bag before the dispensing collection.

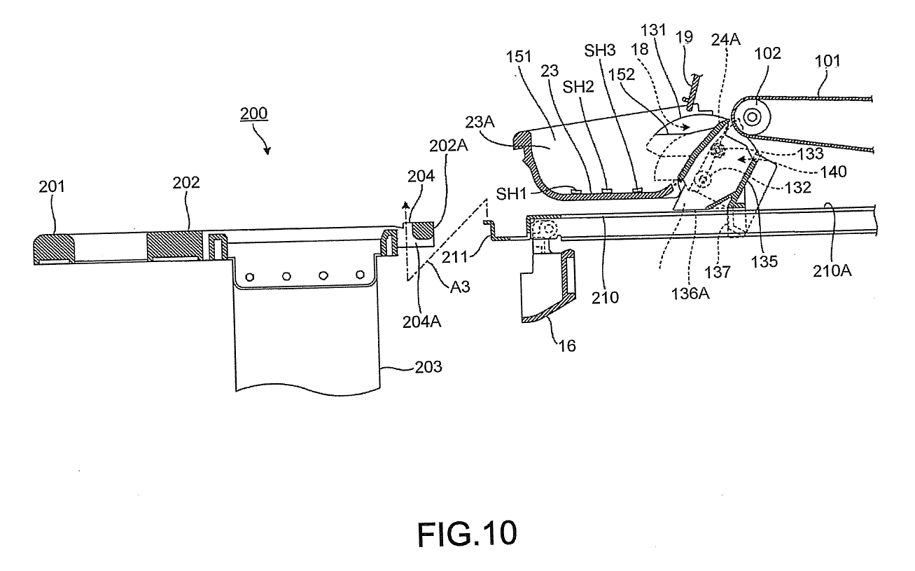

In addition, FIG. 10 is a sectional view corresponding to the state in FIG. 9, taken in the direction of arrows along the line A-A (referring to FIG. 2)

The dispensing-collecting bag 200, as shown in FIG. 9, includes a supporting frame 202 having handle portion 201 made of resin, and a cloth-made collecting bag 203 supported on the supporting frame 202.

If the drawing handle portion 16 arranged below the coin dispensing section 15 is pulled out to the front side, the drawing handle portion 16 rotates downward in the state supported by the collection rail 210, and becomes a state that the collecting bag mounting portion 211 arranged at the front end of the collection rail 210 is exposed.

On the other hand, as shown by the dot and dash line A3 in FIG. 10, the collecting bag mounting portion 211 is inserted into the supporting frame 202 of the dispensing-collecting bag 200, and an engaged portion 204 is arranged so that the dispensing-collecting bag 200 is integrated with the collection rail 210 by engaging with the collecting bag mounting portion 211.

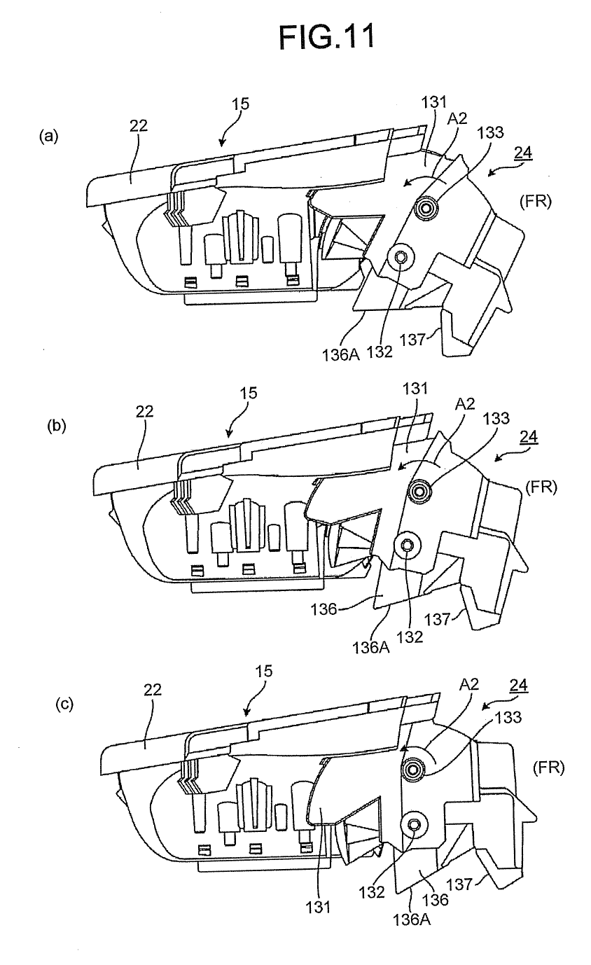

FIG. 11 is a side view illustrating the operating state of the witching member.

Wherein, FIG. 11(a) is an explanatory view of the state before rotation of the switching member 24. FIG. 11(b) is an explanatory view of the state in which the witching member 24 is being rotated. In addition, FIG. 11(c) is also an explanatory view of the state after the rotation of the switching member 24.

FIG. 12 is a perspective view illustrating the operating state of the switching member.

Wherein, FIG. 12(a) is an explanatory view of the state before the rotation of the switching member 24 corresponding to FIG. 11(a). FIG. 12(b) is an explanatory view of the state of the rotation of the switching member 24 corresponding to FIG. 11(b). In addition FIG. 12(c) is an explanatory view of the state after the rotation of the member 24 corresponding to FIG. 11(c).

Before mounting of the dispensing-collecting bag 200 before the dispensing collection operation, as shown in FIG. 10, sliding surfaces 136A of the pair of rotation regulating plates 136 of the switching member 24 contacts the upper surface 210A of the collection rail 210 in a slidable manner.

As a result, the sliding surface 136A of the rotation regulating plate 136 is maintained at a horizontal state, as shown in FIG. 11(a), the rotation of the switching member 24 in the direction indicated by the arrow A2 is limited.

Therefore, as shown in FIG. 10, the movable coin receiving surface 24A is positioned in the dispensing direction of the coin dispensed by the dispensing belt 101 (the obliquely downward direction against the upper surface of the dispensing belt 101 in FIG. 10). In this state, the same as the usual operation, the dispensed coin slides down along the movable coin receiving surface 24A, and is guided to the tray portion 22 of the coin dispensing portion 15 to be retained in the retention portion 23 even if the coin is dispensed.

That is, the coin is retained in the tray portion 22 as a change.

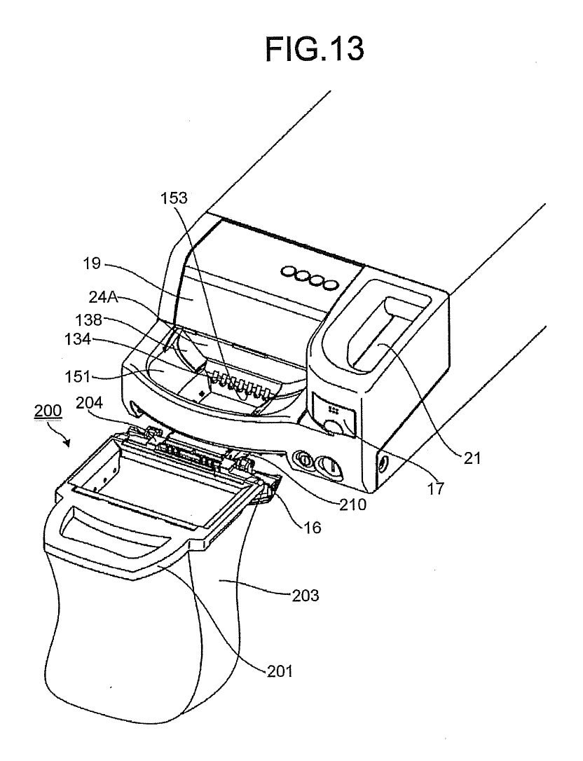

FIG. 13 is a perspective view illustrating a state in which the dispensing-collecting bag is attached to the collection rail.

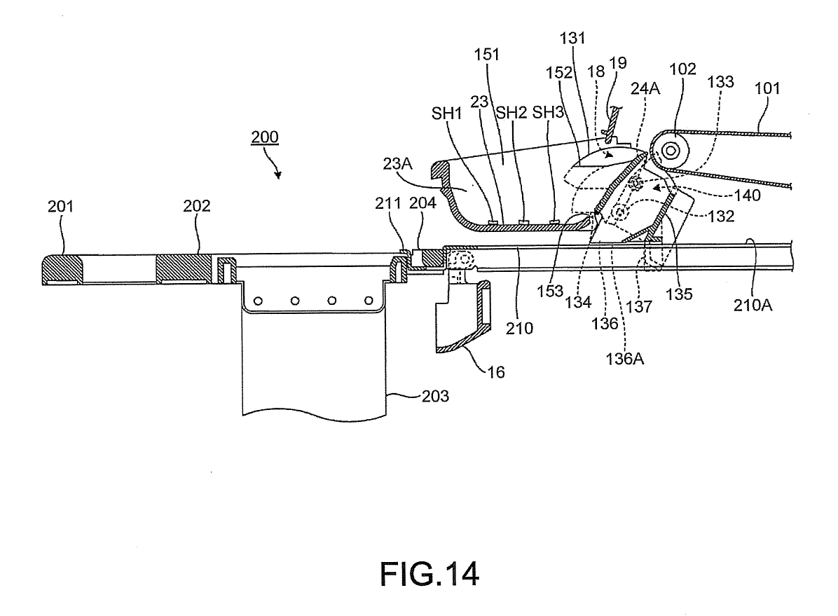

In addition, FIG. 14 is a sectional view corresponding to the state in FIG. 13, taken in the direction of arrows along the line A-A (referring to FIG. 2).

In the state in which the dispensing-collecting bag is attached to the collection rail, the collecting bag mounting portion 211 is inserted into the engaging portion 204A of the dispensing-collecting bag 200, and thus the dispensing-collecting bag 200 engages with the collecting bag mounting portion 211.

As a result, dispensing-collecting bag 200 is integrated with the collection rail 210.

Also in this state, as shown in FIG. 14, the pair of rotation regulating plates 136 of the switching member 24 contacts the upper surface 210A of the collection rail 210 in a slidable manner and the rotation of the switching member 24 toward a direction of arrow A2 (referring to FIG. 11(a)) is limited.

In this state, if the handle portion 201 of the dispensing-collecting bag 200 is pressed forwardly (rightward direction in FIG. 14), the pair of rotation regulating plates 136 of the switching member 24 slides on the upper surface 210A of the collection rail 210 and the front end surface 202A of the supporting frame 202 contacts the pair of abutting members 137 of the switching member 24.

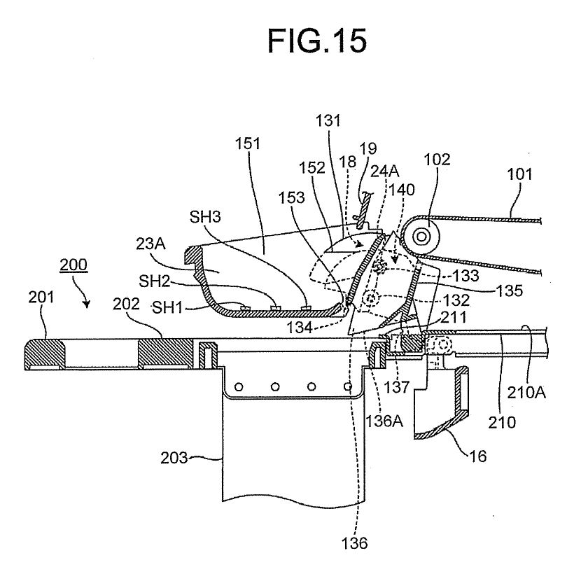

FIG. 15 is a sectional view showing the dispensing-collecting bag, that is further pressed from the state shown in FIG. 13, taken in the direction of arrows along the line A-A (referring to FIG. 2).

In this state, if the handle portion 201 of the dispensing-collecting bag 200 is further pressed forwardly and once the pair of rotation regulating plates 136 of the switching member 24 is disengaged from the upper surface 210A of the collection rail 210, the switching member 24 begins to rotate in the direction of arrow A2 against the urging force of a spring (not shown), as shown in FIG. 11(b) and FIG. 12(b).

However, the pair of rotation regulating plates 136 of the switching member 24 contacts the upper surface of the front end of the supporting frame 202 of the dispensing-collecting bag 200 (the upper surface of right edge part in FIG. 15), and thus the rotation thereof is slightly limited.

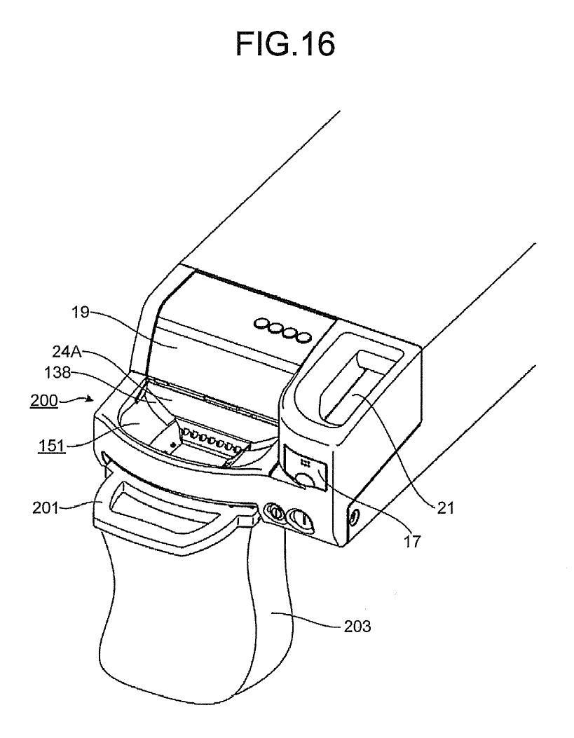

FIG. 16 is a perspective view illustrating a state of the dispensing-collecting bag that is attached to the collection rail and pressed to the dispensing-collecting position.

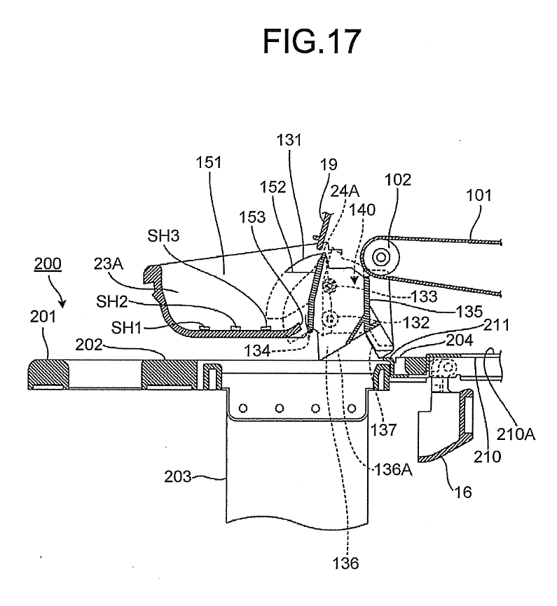

In addition, FIG.17 is a sectional view corresponding to the state of FIG. 16, taken in the direction of arrows along the line A-A (referring to of FIG. 2).

Then, the handle portion 201 of the dispensing-collecting bag 200 is further pressed forward, and if the dispensing-collecting bag 200 reaches to a specified dispensing-collecting position, the front end of the pair of rotation regulating plates 136 of the switching member 24 is located in the apertures of the supporting frame 202, as shown in FIG. 16. Therefore, the limitation of the rotation is removed, as shown in FIG. 11(c), FIG. 12(c) and FIG. 17, the switching member 24 rotates to the maximum rotating state, and the partition plate 135 of the switching member 24 comes to a nearly vertical state.

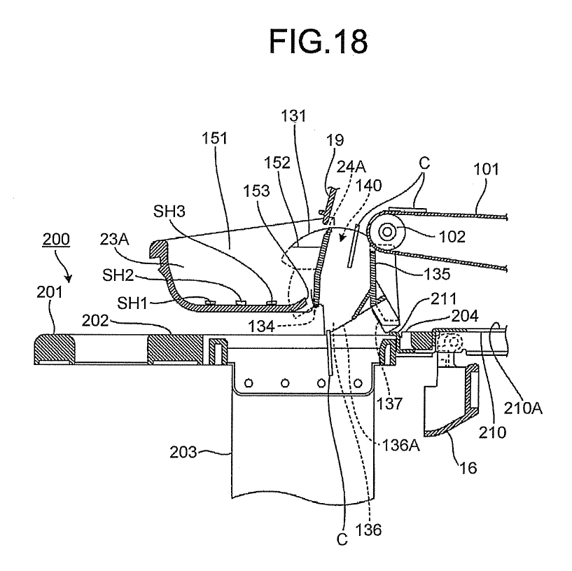

FIG. 18 is an explanatory view illustrating the dispensing collection operation.

As a result, the coin collecting path 140 that is a coin conveying path at the coin collecting operation is located in the dispensing direction of coin dispensed by the coins dispensing belt 101. If coin is dispensed under this state, the coin C dispensed reaches to the coin collecting path 140 and is collected in the dispensing-collecting bag 200 positioned at the lower part of the switching member 24, as shown in FIG. 18.

Then, after all the coins are collected in the collecting bag 203 of the dispensing collecting bag 200 the dispensing-collecting bag 200 is removed in the procedures reverse to the above-described procedures, thereby easily performing the collection of the coins.

As above described, according to the present embodiment, until the dispensing-collecting bag 200 is installed and located at the prescribed dispensing-collecting position, the pair of rotation regulating plates 136 of the switching member 24 contacts the upper surface 210A of the collection rail 210. Therefore, the switching member 24 does not rotate in a casual way even if a user pushes the movable coin receiving surface 24A of the switching member 14.

Even in case in which the switching member 24 is rotated, since a state that the gap is reduced by the insert preventing member is maintained, insertion of the user's nail or finger into the coin depositing and dispensing apparatus 10 can be prevented.

In the above description, the relationship between the width between a pair of collection rails 210, the width between a pair of rotation regulating plates 136, and the width of the aperture of supporting frame 202 of dispensing-collecting bag 200 is not described in detail, but the same can be applied if the sliding surface 136A of the rotation regulating plate pair 136 contacts the upper surface 210A of a pair of collection rails in a slidable manner and both of the pair of rotation regulating plates 136 are narrower than the given width of the aperture of the supporting frame 202 of the dispensing-collecting bag 200.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coin depositing and dispensing apparatus, comprising:
a storing section configured to select and store a deposited coin according to a denomination;
a coin conveying unit configured to convey the coin stored in the storing section;
a switching member configured to switch a coin conveying route of the coin conveying unit to either a coin dispensing path for dispensing the coin from a coin dispensing port or a coin collecting path where a coin collecting bag is provided for collecting the coin; and
a regulating unit configured to restrict the switching to the coin collecting path by the switching member if the coin collecting bag is mounted but not located at a specified coin collecting position.

2. The apparatus according to claim 1, wherein
the regulating unit comes into contact with the switching member to maintain the coin conveying route of the coin conveying unit in the coin dispensing path.

3. The apparatus according to claim 2, wherein
the switching member includes a rotation shaft, and switches the coin conveying route by rotating around the rotation shaft; and
the regulating unit comes into contact with the switching member by the rotation of the switching member.

4. The apparatus according to claim 2, further comprising:
an urging member configured to urge the switching member so as to switch the coin dispensing route to the coin dispensing path side by the switching member, wherein
the coin collecting bag cancels the restriction by the regulating unit as it moves to the coin collecting position together with the regulating unit in an integrated manner and comes into contact with the regulating unit to switch the coin conveying route to the coin collecting path side by rotating the switching member against the urging force by the urging member.

5. The apparatus according to claim 3, wherein
the regulating unit includes amounting unit to which the coin collecting bag is attached and a sliding member that guides the coin collecting bag attached to the mounting unit to the prescribed coin collecting position; and
the switching member includes a contact member which comes into contact with the sliding member when the switching member is rotated to the coin collecting path side.

6. The apparatus according to claim 5, wherein
the contact member is arranged at a position at which the contact member is rotatable in an opening of the coin collecting bag at a point that the coin collecting bag reaches the coin collecting position.

7. The apparatus according to claim 1, wherein
the switching member constitutes a part of the coin tray portion arranged opposite to the coin dispensing port.
